(19) United States
(12) Patent Application Publication
(10) Pub. No.: US 2017/0126168 A1
(43) Pub. Date: May 4, 2017

(54) GRID-LITE ROOF SYSTEM FOR SOLAR PANEL INSTALLATIONS

(71) Applicant: GameChange Solar LLC, New York, NY (US)

(72) Inventor: Andrew Barron Worden, New York, NY (US)

(21) Appl. No.: 15/342,810

(22) Filed: Nov. 3, 2016

Related U.S. Application Data
(60) Provisional application No. 62/250,069, filed on Nov. 3, 2015.

(51) Int. Cl. H02S 20/10

(52) U.S. Cl. CPC H02S 20/10

(57) ABSTRACT

A plurality of mounting posts are each configured to be driven into ground. The mounting post includes opposing parallel sidewalls, a third sidewall extending between, and a fourth sidewall extending between the opposing sidewalls, and opposing and in parallel to the third sidewall. The fourth sidewall includes a longitudinal extending slot with coaxial mounting through holes in the first and second sidewalls at a distal end. A plurality of north-south beams are each mounted on the distal end of an associated one of the posts. Each of the north-south beams comprises a web and first and second flanges extending from the first web. The first and second flanges include first coaxial beam mounting through holes, and include second flanges and second coaxial beam mounting through holes. The first coaxial beam mounting through holes are located closer to the north end than the second coaxial beam mounting through holes, where for each of the north-south beams the web is placed over the distal end of the associated mounting post such that the first coaxial mounting through holes coaxially align with the coaxial beam mounting through holes. A fastener extends through the first coaxial mounting through holes and the coaxial beam mounting through holes to fasten the north-south beam to its associated mounting post.

### CROSS-REFERENCE TO RELATED APPLICATION

This application claims priority from the provisional application designated Ser. No. 62/250,069 filed Nov. 3, 2015 and entitled “Max-Span N Ground System for Solar Panel Installations”, and is hereby incorporated by reference.

### BACKGROUND OF THE INVENTION

1. Technical Field

This disclosure relates generally to a solar panel installation and, more particularly, to apparatuses and assemblies for use in a ground mount solar panel installation on a flat roof.

2. Background Information

Large-scale solar panel arrays are currently provided with two major types of support systems. A first type is referred to as a roof system, which, as the name implies, embodies relatively light structures which are integrated with rooftops and roofing structures. These structures are limited in size as a function of rooftop areas and roof support capabilities.

A second major type of support system is referred to as a “ground system”, which, as opposed to roof systems, can be and often is quite extensive in area (solar panels provide energy as a function of areal sunlight capture and require large areas for viable energy production) and which are accordingly difficult to protect and are highly susceptible to weather conditions. In particular, high or sustained wind conditions may either damage solar panels over time or, more commonly, cause the panels to move out of optimal position for sunlight capture.

Typically, solar panel arrays comprise flat solar panels arranged on supporting structures usually of a fixed grid nature. The supporting structures are configured to hold the panels at an angle relative to the supporting ground such that the solar panels optimally face and capture sunlight for maximum energy conversion.

The structure of a solar panel array includes spaced apart pairs of vertical posts referred to in the art as north and south posts based on their positioning relative to sunlight direction. Other intermediate or otherwise positioned posts such as center posts may be and are often utilized in various support structures with north and south posts being the most common.

Because of the extensive area occupied by viable energy producing solar panels and the large number of panels typically used, efficiencies of scale and proper deployment present numerous problems.

### SUMMARY OF THE DISCLOSURE

According to an aspect of the present disclosure, a mounting system for mounting a solar panel is provided. The mounting system includes a plurality of mounting posts each configured to be driven into the ground leaving a first portion of the mounting post below ground and a second portion of the mounting post above ground. The second portion of the mounting post includes first and second opposing parallel sidewalls, a third sidewall extending between the first and second sidewalls, and a fourth sidewall extending between the first and second sidewalls and opposing and in parallel to the third sidewall. The fourth sidewall includes a longitudinal extending slot that faces in a magnetic north direction, with coaxial mounting through holes in the first and second sidewalls at a distal end of the second portion. A plurality of north-south beams are each mounted on the distal end of an associated one of the plurality of mounting posts and each having a north end and south end. Each of the north-south beams comprises a web and first and second flanges extending from the first web to form a first C-section. A first lip extends outwardly from a distal end of the first flange, and a second lip extends outwardly from a distal end of the second flange. The first and second flanges include first coaxial beam mounting through holes, and include second flanges and second coaxial beam mounting through holes. The first coaxial beam mounting through holes are located closer to the north end than the second coaxial beam mounting through holes, where for each of the north-south beams the web is placed over the distal end of the associated mounting post such that the first coaxial mounting through holes coaxially align with the coaxial beam mounting through holes. A first fastener extends through the first coaxial mounting through holes coaxially aligned with the coaxial beam mounting through holes to fasten the north-south beam to its associated one of the plurality of mounting posts. The mount may include a brace that includes a first end and a second end, where the first end is fastened to an associated one of the plurality of mounting posts and the second end is fastened to an associated one of the plurality of north-south beams via a second fastener and the second coaxial beam mounting through holes. A plurality of parallel purlins may be transversely fastened to a plurality of the adjacent north-south beams.

A roll strap may tautly connect between the parallel purlins and an associated one of the plurality of north-south beams.

The coaxial beam mounting through holes may be located in the first and second flanges at a location that leaves a longer length of the north-south beam on a south side relative to the mounting post when the north-south beam is mounted to the mounting post.

The foregoing features and the operation of the invention will become more apparent in light of the following description and the accompanying drawings.

### BRIEF DESCRIPTION OF THE DRAWINGS

FIG. 1A is a perspective illustration of a post; FIG. 1B is a perspective illustration of a north-south beam that mounts to the post; and FIG. 1C is a perspective illustration of a brace that is fastened to the post and the north-south beam. FIG. 1D is a top view of the second portion 16 of the post 10.

FIG. 2 is a perspective illustration of the north-south beam fastened to a distal end of the post.

FIG. 3 is a perspective illustration of the brace fastened to the post.

FIG. 4 is a side illustration of the mounting system showing the assembled position of the post, the north-south beam and the brace.

FIG. 5 is a perspective illustration of a purlin fastened to the north-south beam.

FIG. 6 is a perspective illustration of a plurality of adjacent posts and north-south beams spanned by purlins, with additional support structures.

FIGS. 7A and 7B are perspective illustrations of a roll strap fastened to an associated north-south beam and a purlin.

### DETAILED DESCRIPTION

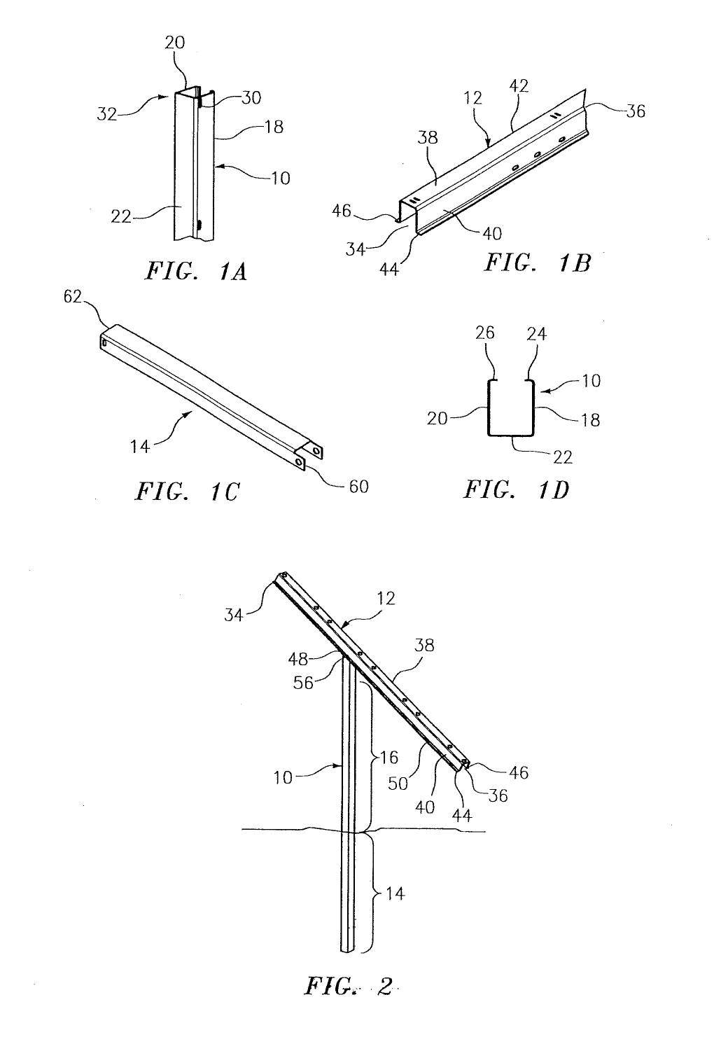

FIG. 1A is a perspective illustration of a portion of a post 10. FIG. 1B is a perspective illustration of a north-south beam 12 that mounts to the post 10. FIG. 1C is a perspective illustration of a brace 14 that is fastened to the post 10 and the north-south beam 12. A mounting system for mounting a solar panel includes a plurality of mounting posts, such as for example the mounting post 10, each configured to be driven into the ground leaving a first portion 14 of the mounting post below ground and a second portion 16 of the mounting post above ground as shown in FIG. 2. FIG. 1D is a top view of the second portion 16 of the post 10. Referring to FIGS. 1A and 1D, the second portion of the mounting post 10 includes first and second opposing parallel sidewalls 18, 20, a third sidewall 22 extending between the first and second sidewalls 18, 20, and a fourth sidewall 24 extending between the first and second sidewalls 18, 20 and opposing and in parallel to the third sidewall 22. The fourth sidewall includes a longitudinal extending slot 26 that faces in a magnetic north direction, with coaxial mounting through holes 30 in the first and second sidewalls at a distal end 32 of the second portion 16.

The mounting system also includes a plurality of north-south beams, such as for example the beam 12 illustrated in FIG. 1B. Each of the north-south beams 12 is configured for mounting on the distal end 32 of an associated one of the plurality of mounting posts 10. FIG. 2 is a perspective illustration of the north-south beam 12 fastened to a distal end of the post 10. Referring to FIGS. 1A, 1B and 2, each of the beams 12 has a north end 34 and south end 36, where each of the north-south beams comprises a web 38 and first and second flanges 40, 42 extending from the web to form a C-section. A first lip 44 extends outwardly from a distal end of the first flange 40, and a second lip 46 extends outwardly from a distal end of the second flange 42. The beam 12 also includes first coaxial beam mounting through holes 48 in the first and second flanges 40, 42, and second coaxial beam mounting through holes 50 in the first and second flanges 40, 42. The first coaxial beam mounting through holes 48 are located closer to the north end 34 than the second coaxial beam mounting through holes 50. To mount a beam the web 38 is placed over the distal end of the associated mounting post 10 such that the first coaxial mounting through holes 48 in the beam 12 coaxially align with the coaxial mounting through holes 30 in the post 10.

A first fastener 56 extends through the first coaxial mounting through holes 48 and the aligned coaxial beam mounting through holes 30 to fasten the north-south beam 12 to its associated one of the plurality of mounting posts 10.

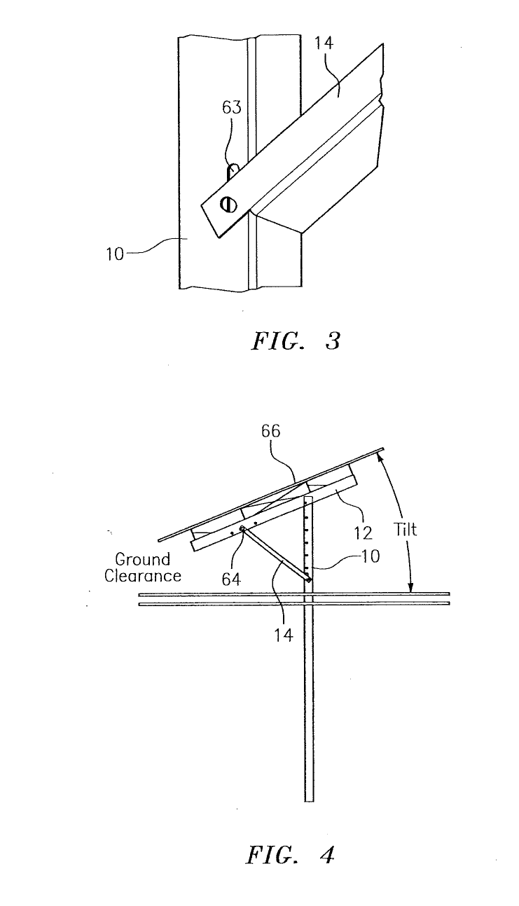

The brace 14 (FIG. 1C) includes a first longitudinal end 60 and a second longitudinal end 62, where the first end 60 is fastened to an associated one of the plurality of mounting posts 10, which includes a slot 63 that allows tilt to be adjusted. FIG. 3 is a perspective illustration of the brace fastened to the post. The second end 62 of the brace 14 is attached to an associated one of the plurality of north-south beams 12 via a second fastener 64 (FIG. 4) and the second coaxial beam mounting through holes 50 (FIG. 2).

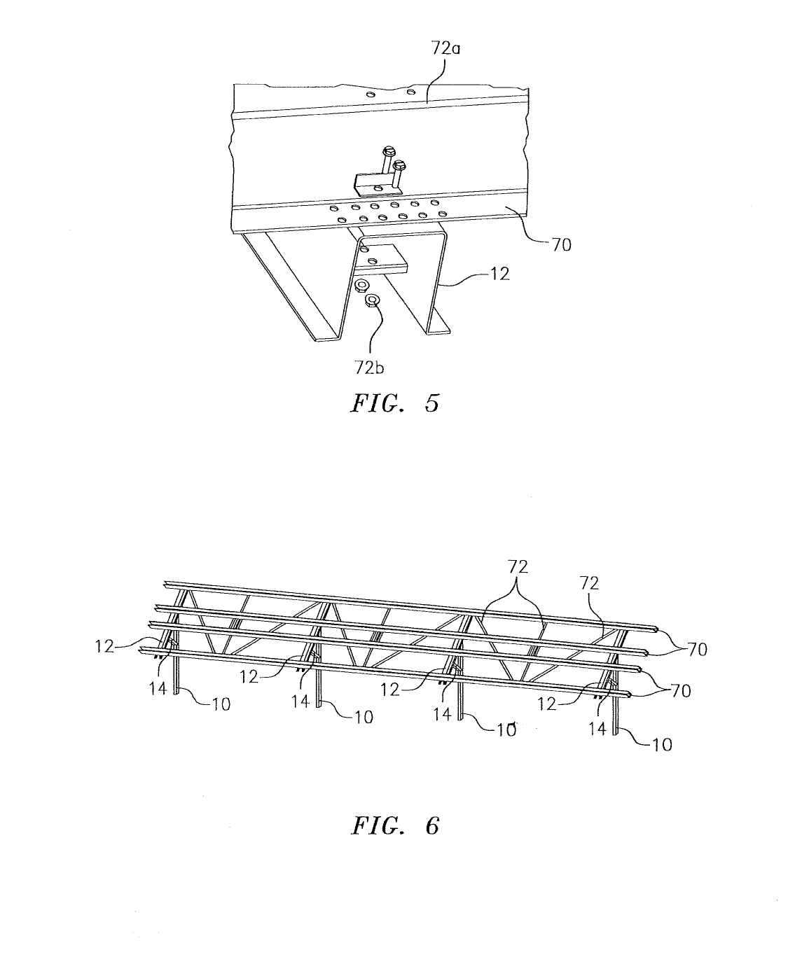

FIG. 4 is a side illustration of the mounting system showing the assembled position of the post 10, the north-south beam 12 and the brace 14 with purlins and a solar panel 66 in place. FIG. 5 is a perspective illustration of a purlin 70 fastened to the north-south beam 12 with fasteners 72a, 72b. FIG. 6 is a perspective illustration of a plurality of adjacent posts 10 and north-south beams 12 transversely spanned by purlins 70, with additional support structures 72. The purlins 70 are fastened to the plurality of the adjacent north-south beams 12, as shown for example in FIG. 5.

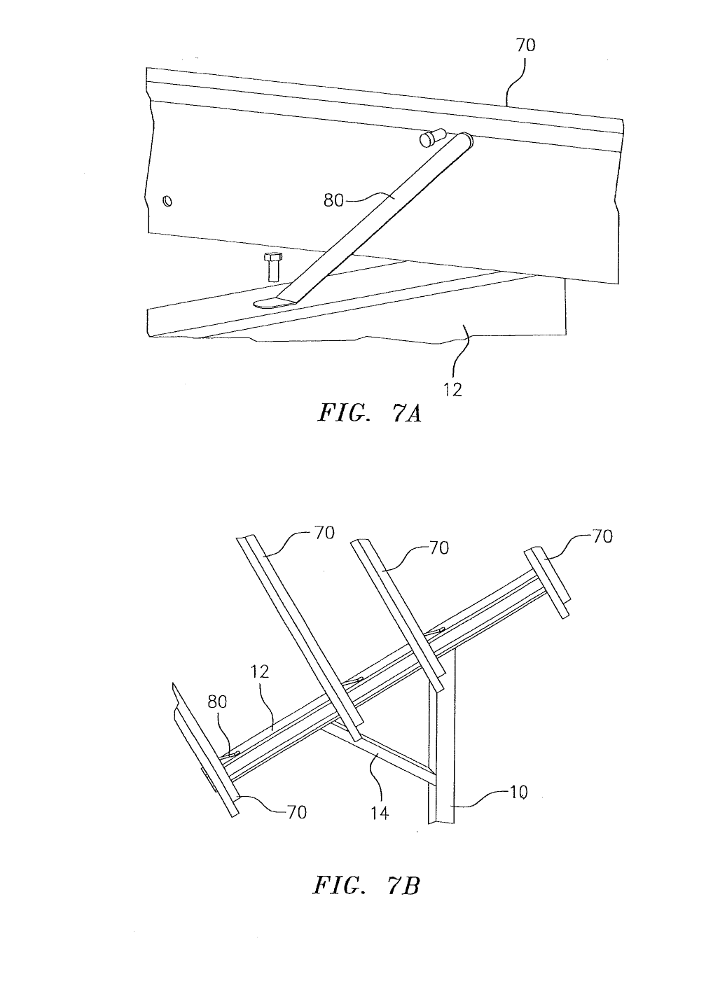

FIGS. 7A and 7B are perspective illustrations of roll straps 80 fastened to an associated north-south beam and a purlin. The roll strap may be tautly connected.

The coaxial beam mounting through holes 48 located in the first and second flanges 40, 42 may be located a location on the beam that leaves a longer length of the north-south beam 12 on a south side relative to the mounting post 10, when the north-south beam 12 is mounted to the mounting post 10.

In one embodiment a solar panel may be fastened to at least two of the plurality of parallel purlins.

The post, beam, and brace may be made of galvanized steel (e.g., G90). However, it is contemplated that any high strength, non-corrosive, weather resistant material, including metallic (e.g., magni coated or stainless steel) and non-metallic materials may be used.

An exemplary embodiment of such a solar panel installation is the Max-Span™ post system designed by the assignee of the present invention, GameChange Racking of New York City, N.Y. Of course, the solar panel installation of the present disclosure is not limited to the specific exemplary embodiment detailed in herein. For examples, one or more system components may be swapped out for components with alternate configurations, one or more the components may be omitted and/or the mounting system may be modified to include one or more additional components not specifically described herein.

While various embodiments of the present invention have been disclosed, it will be apparent to those of ordinary skill in the art that many more embodiments and implementations are possible within the scope of the invention. For example, the present invention as described herein includes several aspects and embodiments that include particular features. Although these features may be described individually, it is within the scope of the present invention that some or all of these features may be combined with any one of the aspects and remain within the scope of the invention. Accordingly, the present invention is not to be restricted except in light of the attached claims and their equivalents.

What is claimed is:

1. A mounting system for mounting a solar panel, the mounting system comprising:
plurality of mounting posts each configured to be driven into ground leaving a first portion of the mounting post below ground and a second portion of the mounting post above ground, where the second portion of the mounting post includes first and second opposing parallel sidewalls, a third sidewall extending between the first and second sidewalls, and a fourth sidewall extending between the first and second sidewalls and opposing and in parallel to the third sidewall, where the fourth sidewall includes a longitudinal extending slot that faces in a magnetic north direction, with coaxial mounting through holes in the first and second sidewalls at a distal end of the second portion;
a plurality of north-south beams each for mounting on the distal end of an associated one of the plurality of mounting posts and each having a north end and south end, where each of the north-south beams comprises a web and first and second flanges extending from the first web to form a first C-section, a first lip extending outwardly from a distal end of the first flange, and a second lip extending outwardly from a distal end of the second flange, with first coaxial beam mounting through holes in the first and second flanges and second coaxial beam mounting through holes in the first and second flanges where the first coaxial beam mounting through holes are located closer to the north end than the second coaxial beam mounting through holes, where for each of the north-south beams the web is placed over the distal end of the associated mounting post such that the first coaxial mounting through holes coaxially align with the coaxial beam mounting through holes;
a first fastener that extends through the first coaxial mounting through holes coaxially aligned with the coaxial beam mounting through holes to fasten the north-south beam to its associated one of the plurality of mounting posts;
a brace that includes a first end and a second end, where the first end is fastened to an associated one of the plurality of mounting posts and the second end is fastened to an associated one of the plurality of north-south beams via a second fastener and the second coaxial beam mounting through holes; and
a plurality of parallel purlins transversely fastened to a plurality of the adjacent north-south beams.

2. The mounting system of claim 1, a roll strap tautly connected between the parallel purlins and an associated one of the plurality of north-south beams.

3. The mounting system of claim 2, where the coaxial beam mounting through holes are located in the first and second flanges at a location that leaves a longer length of the north-south beam on a south side relative to the mounting post when the north-south beam is mounted to the mounting post.

4. The mounting system of claim 3, further comprising a solar panel that is fastened to at least two of the plurality of parallel purlins.

5. A mounting system for mounting a solar panel, the mounting system comprising:
plurality of mounting posts each configured to be driven into ground leaving a first portion of the mounting post below ground and a second portion of the mounting post above ground, where the second portion of the mounting post includes first and second opposing parallel sidewalls, a third sidewall extending between the first and second sidewalls, and a fourth sidewall extending between the first and second sidewalls and opposing and in parallel to the third sidewall, where the fourth sidewall includes a longitudinal extending slot that faces in a magnetic north direction, with coaxial mounting through holes in the first and second sidewalls at a distal end of the second portion;
a plurality of north-south beams each for mounting on the distal end of an associated one of the plurality of mounting posts and each having a north end and south end, where each of the north-south beams comprises a web and first and second flanges extending from the first web to fowl a first C-section, with first coaxial beam mounting through holes in the first and second flanges and second coaxial beam mounting through holes in the first and second flanges where the first coaxial beam mounting through holes are located closer to the north end than the second coaxial beam mounting through holes, where for each of the north-south beams the web is placed over the distal end of the associated mounting post such that the first coaxial mounting through holes coaxially align with the coaxial beam mounting through holes; and
a first fastener that extends through the first coaxial mounting through holes coaxially aligned with the coaxial beam mounting through holes to fasten the north-south beam to its associated one of the plurality of mounting posts; and
a plurality of parallel purlins transversely fastened to a plurality of the adjacent north-south beams.
